(19) United States
(12) Patent Application Publication
(10) Pub. No.: US 2006/0272185 A1
(43) Pub. Date: Dec. 7, 2006

(54) Greeting card holder

(75) Inventors: Kawika J. Malama, Greeley, CO (US); Kelly Malama, Greeley, CO (US)

Correspondence Address: Starkweather and Associates, Suite 200, 9035 South 1300 East, Sandy, UT, 84094, US

(73) Assignee: EXPRESSIONS-A-BOUND, LLC

(21) Appl. No.: 11/144,535

(22) Filed: Jun. 3, 2005

(51) Int. Cl. B42D 1/00; G09F 1/00

(52) U.S. Cl. 40/124.01; 281/21.1

(57) ABSTRACT

A holding device for adapting foldable cards to be secured in a binder. There is a securing tab and a first and second attachment wings. The securing tab includes a first surface, a second surface, and a base. The securing tab removably attaches to the binder. The first and second attachment wings are hingedly extending from the first surface and second surface of the securing tab at the base respectively and are configured to fixedly attach to the foldable card about a fold line in the foldable card on a first and second portion of the fold line respectively. The holding device has a length no greater than a length of the fold line. There are perforations for removing portions. There is non-permanent adhesive. There is a card. There is a third attachment wing. There is only one attachment wing.

### BACKGROUND OF THE INVENTION

1. Field of the Invention

The present invention relates to greeting card holders, specifically to greeting card holders that permit simultaneous storage and viewing of greeting cards.

2. Description of the Related Art

One of the most prevalent customs in the United States is exchanging greeting cards. There are a great variety of types of greeting cards configured to be appropriate for nearly all occasions. A substantial majority of households, estimated at over 90%, send and receive greeting cards, typically dozens per household per year.

Greeting cards communicate special thoughts and feelings from one person to another. Some are powerful expressions of love, appreciation, comfort, congratulations, etc. Further, greeting cards typically include space for a sender to write down very special and particularized sentiments. These sentiments may represent a person's most valuable and treasured moments, connections, relationships, possessions, etc. However, after an initial viewing or display, they are often discarded or hidden away.

Some effort has been spent in finding ways to preserve greeting cards as the physical embodiments of these sentiments. Receivers may store the cards in a drawer, or file them in a folder, binder, book, or other means for storing the cards. However, when stored in a book or binder, the greeting cards are stored in pouches. Thus, the greeting cards must be removed from the pouches to be opened and viewed, a frustrating and cumbersome process that detracts from re-experiencing the sentiments of the card.

There are also binders and books including retaining segments configured to hold a card when the card is folded about the segment. These binders and books permit simultaneous storage and facilitated viewing, but do not secure the cards well, resulting in a fragile arrangement of cards, wherein moving any portion of the book/binder or cards out of a preferred position may result in cards falling out of the book/binder. The care needed to handle such displays and the resulting frustration from improper handling detracts from enjoying the cards.

Further, there are storage/display means wherein the cards are glued in various ways to an attachment piece or a display book. However, these methods often restrict the ability to selectably remove the greeting card from the storage container. Also, these methods may restrict the ability to open the cards for proper viewing of the contents. For example, they may pinch a portion of the card, making opening the card difficult and frustrating and may not permit viewing of the entire inside of a card. In another example, an entire face of the card may be impossible to view without destroying material.

What is needed is a greeting card holder that solves one or more of the aforementioned problems.

### SUMMARY OF THE INVENTION

The present invention has been developed in response to the present state of the art, and in particular, in response to the problems and needs in the art that have not yet been fully solved by currently available greeting card holders. Accordingly, the present invention has been developed to provide a greeting card holder that may securely store a greeting card and may have enhanced viewing characteristics.

In one embodiment there is a holding device for adapting foldable cards to be secured in a binder. The holding device may include a securing tab and first and second attachment wings. The securing tab may include a first surface, a second surface, and a base. The securing tab may be configured to removably attach to the binder. The first and second attachment wings may be hingedly extending from the first surface and second surface of the securing tab at the base respectively. Also, the first and second attachment wings may be configured to fixedly attach to the foldable card about a fold line in the foldable card on a first and second portion of the fold line respectively. It may be that the holding device has a length no greater than a length of the fold line.

Also it may be that the first attachment wing includes a wing removal perforation extending along a length of the first attachment wing. Additionally, the first attachment wing may be configured to enable removal of a portion of the first attachment wing from the holding device.

There may also be a length adjustment perforation that may extend substantially perpendicular to the base through the securing tab. The length adjustment perforation may extend through the first and second attachment wings. The length adjustment perforation may be configured to enable removal of a portion of each of the securing tab, and/or the first and second attachment wings.

In one embodiment the first and second attachment wings may include a non-permanent adhesive that may extend along portions of the first and second attachment wings intended to be in contact with the foldable card.

Also, the holding device maybe integral to the foldable card. The holding device may be attached to a foldable card prior to purchase by a consumer. The holding device may be attached to a foldable card after purchase by a consumer.

In one embodiment there may be a third attachment wing that may be hingedly extending from the securing tab at the base, and may be configured to fixedly attach to a second foldable card about a fold line in the foldable card.

There may be a substantially transparent pocket coupled to the securing tab and that may be configured to enable attachment of a label to the holding device by insertion of the label into the pocket.

In one embodiment there may be a holding device for adapting foldable cards to be secured in a binder. The holding device may include a securing tab and a first attachment wing. The securing tab may have a first surface and a base, wherein the securing tab may be configured to removably attach to the binder. The first attachment wing may be hingedly extending from the first surface of the securing tab at the base, and may be configured to fixedly attach to the foldable card. The holding device may have a length no greater than a length of the fold line.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a front perspective view of a greeting card holder affixed to a greeting card according to one embodiment of the invention;

FIG. 2 illustrates a front plan view of an open greeting card attached to a greeting card holder according to one embodiment of the invention;

FIG. 3 illustrates a side plan view of a greeting card holder affixed to an open greeting card according to one embodiment of the invention;

FIG. 4 illustrates a front plan view of a greeting card holder affixed to a greeting card and selectably attached to a binder according to one embodiment of the invention; and

FIG. 5 illustrates a front perspective view of a partially removed attachment wing on a greeting card holder according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

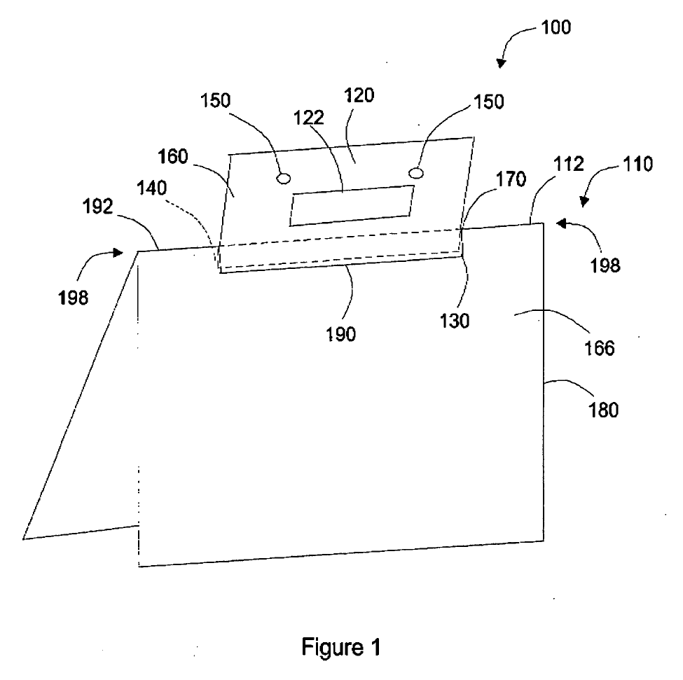

FIG. 1 illustrates a front perspective view of a greeting card holder 100 affixed to a greeting card 110 according to one embodiment of the invention. The greeting card holder, or holding device 100, is affixed to the folded greeting card 110 along a fold line 112. The greeting card holder 100 includes a securing tab 120, a first attachment wing 130, and a second attachment wing 140.

The securing tab 120 includes means for removably attaching to another device. In particular, in the illustrated embodiment, there are a pair of holes 150 in the securing tab 120. The pair of holes 150 are configured to accept rings in a binder, thereby permitting removable attachment of the securing tab 120 to a binder. It is understood that any structure facilitating removable attachment of the securing tab to a device configured to collect and/or store substantially flat object may be included in the securing tab 120. For example, the securing tab may include a strip of hook and loop material, snaps, buttons, button-holes, strings, loops, and/or may be of sufficient thickness and/or have sufficient friction along a surface to permit frictional attachment of the securing tab 120 to a device.

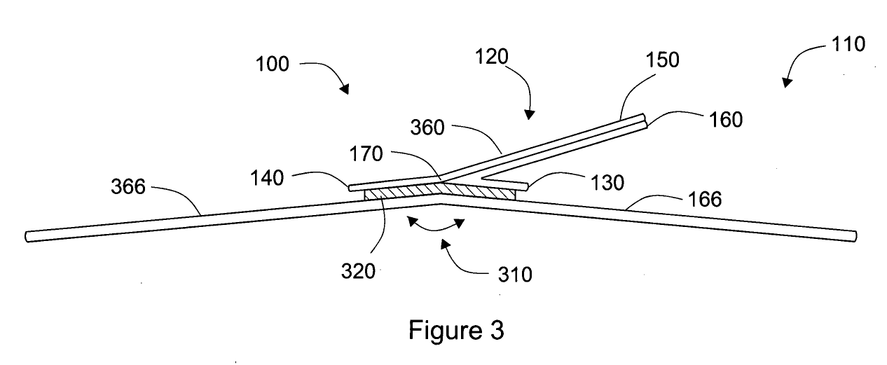

The securing tab 120 further includes a first surface 160, a second surface 360 (see FIG. 3), and a base 170. The securing tab 120 may be symmetrical such that the first surface 160 mirrors the second surface 360. Further, the first surface 160 may be parallel to the second surface 360. Typically the base 170 will extend linearly along one edge of the securing tab 120, thereby extending linearly along one edge of each of the first surface 160 and second surface 360. Preferably, the securing tab 120 is generally rectangular and planar, thereby providing a generally flat profile for facilitating efficient adjacent placement of multiple greeting card holders 100 while also minimizing manufacture waste associated with manufacturing curved members from generally rectangular materials.

The first attachment wing 130 and second attachment wing 140 each hingedly extend from the base 170 of the securing tab 120 from the first surface 160 and second surface 360 respectively. The first attachment wing 130 and second attachment wing 140 are preferably generally coextensive and generally symmetrical one to another. Also, the distance to which each extends from the base 170 is preferably small compared to a width 180 of a greeting card 110.

The first attachment wing 130 and second attachment wing 140 are each configured to attach to a greeting card, thereby fixing the securing tab 120 to the greeting card 110. Preferably, the first attachment wing 130 and second attachment wing 140 are configured to attach to a greeting card, or foldable card 110, about a fold line 112 in the greeting card 110, wherein the first attachment wing 130 may be fixed at a first side 166 of the fold line 112 and the second attachment wing 140 may be fixed at a second side 366 (see FIG. 3) of the fold line 112. When attached to the greeting card 110, the first attachment wing 130 and the second attachment wing 140 may extend parallel to each of the respective sides of the greeting card 110. The base 170 of the greeting card holder 100 may extend parallel to the fold line 112 of the greeting card 110.

The attachment between the greeting card 110 and the attachment wings 130 and 140 may be by a glue or adhesive, or any other means of attaching materials, including but not limited to hook and loop, magnets, snaps, buttons, ties, interlocking members, etc. Preferably, the attachment between the greeting card 110 and the attachment wings 130 and 140 is a substantially rigid attachment, and may be a substantially permanent attachment. Preferably damage to the greeting card 110 is minimized and obstruction of viewable portions of the greeting card 110 are also minimized.

It is preferably that a holding device length 190, preferably including at least the shorter of a length of the first attachment wing 130 or a length of the second attachment wing 140, be no longer than a length 192 of the fold line 112 in the greeting card 110. Thereby, the greeting card holder 100 may affix to the greeting card 110 only co-extensively with the fold line 112 of the greeting card 110. Therefore, the greeting card holder may be affixed to the greeting card 110 without substantial interference with opening the greeting card 110 for viewing, especially at peripheral edges 198 of the greeting card 110. Otherwise the greeting card holder 100 may pinch and hold shut the peripheral edges 198 of the greeting card 110.

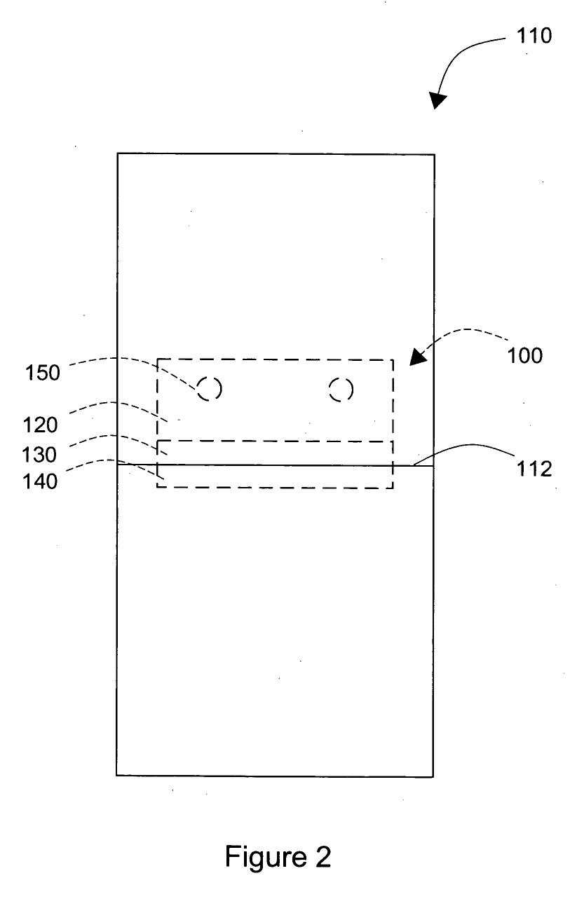

FIGS. 2 and 3 illustrate front and side plan views of an open greeting card 110 attached to a greeting card holder 100 according to one embodiment of the invention. The greeting card 110 is in a fully open configuration (open to an angle 310 between a first side 166 and a second side 366 of about 180 degrees), permitted by the configuration of the greeting card holder 100 affixed thereto. In particular, the greeting card holder 100 is configured to include a first surface 160, a second surface 360, a first attachment wing 130, a second attachment wing 140, a securing tab 120, a length 190, and a base 170.

The greeting card holder 100 is preferably fixedly attached to the greeting card 110 at the first and second attachment wings 130 and 140 by a fastener 320 that may be, but is not limited to, glue or other adhesive. Preferably the first and second attachment wings 130 and 140 are configured to be parallel to the first and second sides 166 and 366 respectively. Further, the length 190 of the greeting card holder 100 is less than a greeting card length 192. Therefore, the greeting card 110 may be opened to large angles without significant resistance from the greeting card holder 100. The first and second surfaces 160 and 360 may be two separate pieces that may be fixed one to another or may be integrated as different sides of a single piece.

Additionally, wherein the greeting card holder is smaller than an open greeting card 110 the open greeting card 110 may advantageously obscure an entirety of the greeting card holder 100. Also, advantageously, the greeting card holder 100 permits opening of the greeting card 110 to angles 310 greater than about 180 degrees even while attached to a binder (not shown), wherein the permitted angle is mathematically related to a securing tab length.

In operation, a greeting card holder 100 may be affixed to a greeting card 110. While the greeting card holder 100 is attached, even rigidly attached, the user may open the greeting card 110 for viewing. Further, an opening of the greeting card 110 is not restricted by the greeting card holder 100. In particular, in one embodiment the greeting card holder 100 does not pinch or otherwise exert substantial force tending to open or close the greeting card 110. Also, the greeting card holder 100 may permit a substantially flat profile for both the greeting card 110 and the greeting card holder 100 when the greeting card 110 is substantially fully open and/or substantially fully closed.

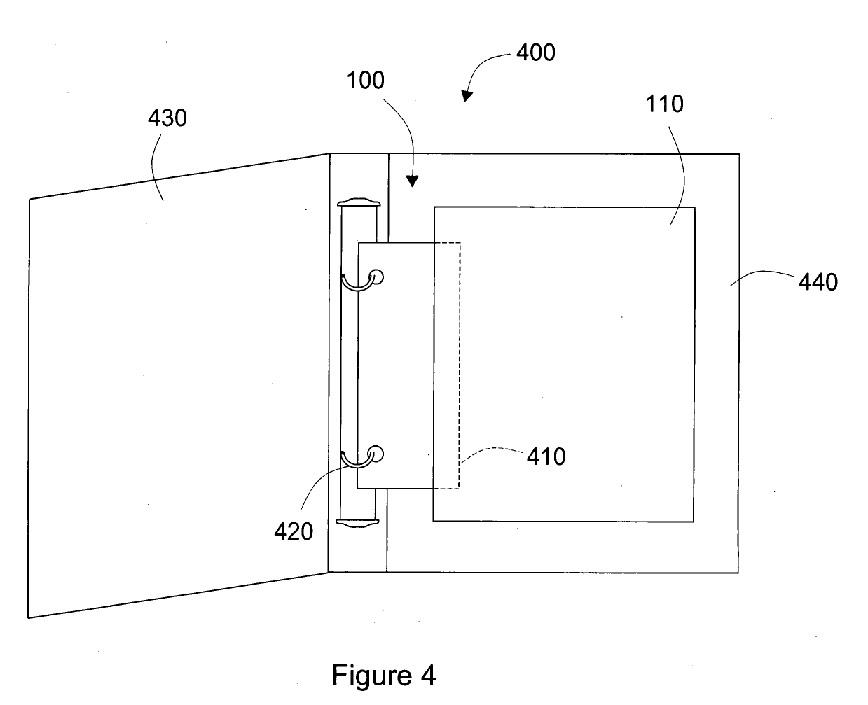

FIG. 4 illustrates a front plan view of a greeting card holder 100 affixed to a greeting card 110 and selectably attached to a binder 400 according to one embodiment of the invention. Although a particular binder 400 is illustrated, the term “binder” as used in this application is intended to include any device configured to permit selectable attachment thereto. Preferably a binder 400 will be configured to display, store, and/or protect attached items.

In the illustrated example, there is a greeting card 110 attached to a greeting card holder 100 at an attachment wing 410 that is coupled to a securing tab 120 removably attached to a binder 400 at a pair of rings 420. The binder 400 includes a front cover 430 and a back cover 440 configured to protect and/or enable storing of greeting cards 110 attached therein. The greeting card 110 may be attached to a single attachment wing 410 or a pair of attachment wings (see FIGS. 1-3). The greeting card 110 may be attached with a non-permanent adhesive, such as that used in Post-It® branded notes, thereby permitting easy removal and attachment as well as repeated removal and attachment for reorganization of materials. Wherein there is only a single attachment wing 410, there may be advantageously greatly reduced manufacturing costs.

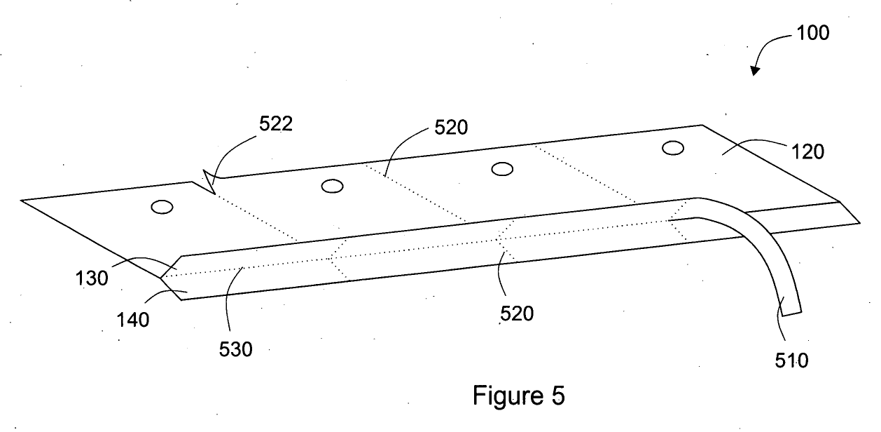

FIG. 5 illustrates a front perspective view of a partially removed attachment wing 510 on a greeting card holder 100 according to one embodiment of the invention. There is shown a greeting card holder 100 having a first attachment wing 130 and a second attachment wing 140. Further shown are length adjustment perforations 520 (shown by dashed lines) configured to enable a user to alter a greeting card holder length by discreet amounts corresponding to the location of each length adjustment perforation 520. Still further shown is a wing removal perforation 530 (shown by a dashed line) configured to enable a user to remove an attachment wing, in the illustration the first attachment wing 130.

In operation, a user may have one or more greeting card holders 100 that may include one or more length adjustment perforations 520 and that may contain one or more wing removal perforations 530. A user may tear, break, or otherwise separate a greeting card holder at one or more of the perforations to alter the greeting card holder to adapt to particular needs. For example, where a user may not want to cover any of a side co of a greeting card (see FIG. 4) one attachment wing may be removed by tearing at a wing removal perforation 530, thereby leaving a single attachment wing 410 (see FIG. 4). Further, a wing removal perforation may remove only a portion of a wing, for example shortening an amount extending from the securing tab 120.

More, a user may tear 522 a greeting card holder 100 at one or more length adjustment perforations 520, thereby adjusting a greeting card holder length and/or enabling the use of two greeting card holders 100 from materials constituting a single larger greeting card holder 100. Using these perforations, a greeting card holder 100 may be adjusted dramatically to any size and/or length to bind from very large objects to very small objects.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although general proportions may be illustrated, the invention is not restricted to the proportions illustrated. In particular, the fastener shown in FIG. 3 is greatly exaggerated for most types of fasteners and has been exaggerated for clarity in the drawing. Additionally, while securing tabs are shown having holes for attachment to binders, any attachment means in the art in contemplated. Therefore the invention is not restricted to any particular configuration of holes or any other specific attachment means.

Additionally, although the figures illustrate using greeting card holders together with greeting cards, it is envisioned that greeting card holders may be used with a great variety of objects and/or materials. For example, but not in way of limitation, greeting card holders may be used to attach, store, protect, organize, etc. items such as: programs, flyers, graduation announcements, keepsakes, brochures, photographs, ticket stubs, odd-sized papers, blueprints, schematic drawings, warranties, instruction manuals, recipes, writing instruments, bags containing one or more objects, etc.

It is expected that there could be numerous variations of the configuration of this invention. An example is that the greeting card holder may be constructed of soft transparent plastic holding a liquid inside containing ornamental devices such as small shiny metallic pieces. In another example, an attachment wing may include a prophylactic strip covering an adhesive, wherein during operation a user may remove the prophylactic strip, thereby exposing the adhesive, before attaching the attachment wing to a greeting card. There may be a strip of adhesive along a length of a first and a second attachment wing that may be applied during manufacture and may be exposed when a covering of a strip of material is removed. There may be a binder configured to include one or more greeting card holders that may be integral to the binder. There may be a greeting card holder that may be configured to be one step away from having a functional securing tab. For example, the securing tab may not have pre-punched holes, thereby permitting a user to select a location for hole punching. In another example, there may be a plurality of perforations in likely desired locations, wherein the perforations are configured to facilitate punching one or more holes in the securing tab.

In still another example, the greeting card holder may include more than two attachment wings, thereby enabling attachment of a plurality of materials to a single securing tab. In still yet another example, a securing tab and/or an attachment wing may include a plurality of attachment means, enabling attachment to a plurality of diverse binders and/or objects. I still yet another example, a greeting card holder may be integral to a greeting card. In a still yet further example, a greeting card holder may include a pocket in a securing tab, wherein the pocket may be transparent and may enable labeling or otherwise inserting tags or other similar objects therein.

Finally, it is envisioned that the components of the device may be constructed of a variety of materials, such as but not limited to: paper, fabric, fiber, plastic, metal (such as metal foil), composite, wood, and resin. Material that may be used as an adhesive, glue, tacky material etc. may be permanent or non-permanent. Further, it is also envisioned that the device may be constructed of a plurality of materials. For example, without limitation, a securing tab may be plastic and an attachment wing may be fabric.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A holding device for adapting foldable cards to be secured in a binder, comprising:
a securing tab having a first surface and a base, wherein the securing tab is configured to removably attach to the binder;
a first attachment wing hingedly extending from the first surface of the securing tab at the base, and configured to fixedly attach to the foldable card, wherein the holding device has a length no greater than a length of a fold line of the foldable card; and
a substantially transparent pocket coupled to the securing tab and configured to enable attachment of a label to the holding device by insertion of the label into the pocket.

14. The holding device of claim 13, further comprising a length adjustment perforation extending substantially perpendicular to the base through the securing tab and the first attachment wing and configured to enable removal of a portion of each of the securing tab and the first attachment wing.

15. The holding device of claim 13, wherein the first attachment wing includes a wing removal perforation extending along a length of the first attachment wing and configured to enable removal of a portion of the first attachment wing from the holding device.

16. (canceled)

17. The holding device of claim 13, wherein the holding device is integral to the foldable card.

18. The holding device of claim 13, wherein the first attachment wing includes a non-permanent adhesive extending along a portion of the first attachment wing intended to be in contact with the foldable card.

19. The holding device of claim 14, further including a substantially transparent pocket coupled to the securing tab and configured to enable attachment of a label to the holding device by insertion of the label into the pocket.

20. The holding device of claim 19, wherein the first attachment wing includes a non-permanent adhesive extending along a portion of the first attachment wing intended to be in contact with the foldable card.

21. A holding device for adapting foldable cards to be secured in a binder, comprising:
a securing tab having a first surface, a second surface, and a base, wherein the securing tab is configured to removably attach to the binder;
first and second attachment wings, hingedly extending from the first surface and second surface of the securing tab at the base respectively, and configured to fixedly attach to the foldable card about a fold line in the foldable card on a first and second portion of the fold line respectively, wherein the holding device has a length no greater than a length of the fold line; and
a substantially transparent pocket coupled to the securing tab and configured to enable attachment of a label to the holding device by insertion of the label into the pocket.

22. The holding device of claim 21, wherein the first and second attachment wings include a non-permanent adhesive extending along portions of the first and second attachment wings intended to be in contact with the foldable card.

23. The holding device of claim 21, wherein the first attachment wing includes a wing removal perforation extending along a length of the first attachment wing and configured to enable removal of a portion of the first attachment wing from the holding device.

24. The holding device of claim 21, wherein the holding device is integral to the foldable card.

25. The holding device of claim 21, wherein the first attachment wing includes a wing removal perforation extending along a length of the first attachment wing and configured to enable removal of a portion of the first attachment wing from the holding device, further wherein the holding device is integral to the foldable card.

26. A holding device for adapting foldable cards to be secured in a binder, comprising:
a securing tab having a first surface and a base, wherein the securing tab is configured to removably attach to the binder;
a first attachment wing hingedly extending from the first surface of the securing tab at the base, and configured to fixedly attach to the foldable card, wherein the holding device has a length no greater than a length of a fold line of the foldable card;
a length adjustment perforation extending substantially perpendicular to the base through the securing tab and the first attachment wing and configured to enable removal of a portion of each of the securing tab and the first attachment wing.
a substantially transparent pocket coupled to the securing tab and configured to enable attachment of a label to the holding device by insertion of the label into the pocket.

27. The holding device of claim 26, wherein the first attachment wing includes a non-permanent adhesive extending along a portion of the first attachment wing intended to be in contact with the foldable card.
